(19) United States
(12) Patent Application Publication
(10) Pub. No.: US 2005/0225886 A1
(43) Pub. Date: Oct. 13, 2005

(54) Mirror angle transducer and mirror tilting mechanism

(75) Inventor: Ayako Yamada, Shizuoka (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: MURAKAMI CORPORATION, Shizuoka-shi (JP)

(21) Appl. No.: 11/045,119

(22) Filed: Jan. 31, 2005

(30) Foreign Application Priority Data
Apr. 7, 2004 (JP) 2004-113183

(51) Int. Cl. G02B 7/182

(52) U.S. Cl. 359/877; 359/872

(57) ABSTRACT

A mirror angle transducer that detects tilting angles of a mirror applied to vehicles, wherein the tiling angle is adjusted by an adjuster element installed in an actuator housing, comprises a guide that has a non-circular hollow and composes the adjuster element, a sliding block that has a hole and is inserted into the non-circular hollow of the guide, a resistor strip that has a resistive layer and a conductive strip layer on one surface and the other surface, respectively and is set in the hole of the sliding block, a sliding contactor that makes electrical contact with the resistor by pinching and sliding on the surfaces of the resistor strip, and a coupling means that provides mechanically tight combining of the sliding contactor to the sliding block so that a stable and reproducible positioning of the electrical contactor on the resistor strip is obtained.

### CROSS-REFERENCE TO RELATED APPLICATION

The disclosure of Japanese Patent Application No. 2004-113183 filed on Apr. 7, 2004 including the specification, drawings and abstract is incorporated herein by reference in its entirety.

### FIELD OF THE INVENTION

The present invention relates to a transducer to detect the tilt angle of mirrors used for various vehicles so that the sight angle of the mirrors can be adjusted by remote controlling technologies and a mechanism that works in corporation with the transducer in a configuration of an actuator for the mirror.

### BACKGROUND OF THE INVENTION

As for the mirror used for the vehicles, it is necessary to change the sight angle of the mirror in accordance with the attitude of the driver for safety reasons. Since it is a nuisance to handle or manipulate the mirror and adjust the sight angle of the mirror, remote manipulations of the mirrors by which the sight angles can be adjusted are generally used now-a-day. As for the mechanism used for such remote manipulations of the mirrors, two adjustment nuts are equipped for controlling the sight angles of the mirror in a vertical plane and horizontal plane by moving these adjustment nuts forward or backward. When one adjustment nut linearly moves forward or backward, the mirror tilts upward or downward. When the other adjustment nut linearly moves forward or backward, then the mirror swivels leftward or rightward. By changing the mirror in such directions, it is possible to adjust the sight angle of the mirror to be directed to provide a preferable sight for the vehicle driver.

The preferred sight angles of the mirrors used for the vehicles are generally different for drivers. Therefore the different drivers adjust the sight angles of the mirrors every time the drivers change. In case of garaging the vehicles, it is preferred to tilt the mirror downward to watch the rear wheels and the surrounding obstacles. It is weary to adjust the mirror angle every time the driver to garage the vehicle. Therefore, a mirror angle detector has been developed. When this angle detector is associated with the mirror angle adjustment mechanism, it is possible to memorize the preferable mirror angle and set the mirror angle to the previously memorized one. If there are several drivers for a vehicle, it is quite possible to simply obtain the preferable angles for the drivers by memorizing the preferable angles. A single action for the mirror angle adjustment can be done upon garaging the vehicles. The angle tilting mechanism and mirror position detecting device to adjust the mirror sight angles have been disclosed, for example, in the reference 1.

FIG. 6 shows a cross sectional view of the major component (we call adjuster element, hereinafter) used for an angle tilting mechanism disclosed in the reference 1. The adjuster element 102 comprises a guide 108 which has a projection having a screw thread 108a therearound, an adjust nut 110 which has a globe pivot 110a, five nail portions 110b in screw contact with the screw thread 108a of the guide 108 and a stopper 110c in the cylindrical portion, a sliding block 107 which is inserted into the guide 108 but not rotated with the guide 108, a resistor strip 104 which is put in the sliding block 107, a sliding contactor 106 which pinches the head and tail surfaces of the resistor strip 104 and has the electrical contact therewith and a coil spring 105 which pushes the sliding block 107 upward. The sliding contactor 106 is fixed with the sliding block 107 and is not rotated with the sliding block 107.

Reference 1:

Paragraph 0014, FIG. 6, Japanese Laid-Open Application H10-264726, A (1998)

In the adjuster element 102 used for the conventional mirror anlge detecting device, the sliding contactor 106 is pushed to the adjust nut 110 by the coil spring 105 with the sliding lock 107 and therefore the sliding contactor 106 tends to rotate with the adjusting nut 110. Though the sliding contactor 106 which has a shape of a pair of tweezers and is inserted into the sliding block 107 suppresses its own rotation by the pushing force against the internal surface of the sliding block 107, the sliding contactor 106 tends to rotate together with the adjustment nut 110 that results in the repositioning of the sliding contactor 106 on the resistor strip 104 in addition to the contact position of the sliding contactor 106 determined by the movement in the linear direction driven by the screw rotation of the adjust nut 110. In other words, the friction between the sliding block 107 and the adjustment nut 110 gives a force to result in a fluctuation of the contact position due to allowance between the sliding block 107 and the guide 108. Such fluctuation of the contact position causes lack of the stable contact or lack of the repeatability of the electrical contact between the sliding contactor 106 and the resistor strip 104.

The friction of the sliding contactor 106 with the adjust nut 110 which rotates in tilting the mirror generates a twist force to the sliding contactor 106. Therefore the contact between the sliding contactor 106 and the resistor strip 104 is fluctuated by such twist force that results in loosening of the pinching force of the sliding contactor 106 against the resistor strip 104. Such twist force changes the contact from a line contact to a point contact on the surface of the resistor strip 104. Since the sliding contactor 106 and the resistor strip are used for the electrical transducer to determine the relative position of the sliding contactor 106 on the surface of the resistor strip 104. Therefore, the change of the contact mode from a line contact to a point contact generates another fluctuation of electrical characteristics as contact resistance. In other words, the twist force provides in-time degradation of contact resistance and the change of the contact mode causes fluctuations in the measurement of the resistance. These cause the loosening of the resolution of the measurement and the loosening of the precise position determination of the sliding contactor 106 on the resistor strip 104 that results in less repeatability of the measurement.

### BRIEF SUMMARY OF THE INVENTION

The present invention is to provide a mirror angle transducer that solves such unstable contact that results in lack of the reproducible determination of the mirror sight angle and has the purpose to provide high repeatability and high resolution for the transducer to detect the tilt angle of the mirror used for the vehicles. The present invention further provides a mirror angle adjust mechanism that has a capability to provide high repeatability and high resolution by using the transducer to detect the tilt angle of the mirror used for the vehicles in such high resolution and repeatability.

In order to solve the instability and fluctuation of the contact between the sliding contactor 106 and the resistor strip 104, the pinching force of the sliding contactor 106 to the resistor strip 104 should not be changed by the rotation of the adjust nut mechanism. For this purpose, the inventor proposes a coupling means that provides mechanically tight combining of the sliding contactor 106 to the resistor strip 104.

No mechanical play between the sliding contactor and a sliding mechanism that linearly moves along the longitudinal direction of the resistor strip is made by using such a coupling means. As the result, a stable and reproducible positioning of the electrical contact of the sliding contactor on the resistor strip is obtained.

Since the resistor strip is set in the sliding mechanism, the hole of the adjuster element of the mirror angle can be made into compact physical dimensions.

For such a coupling means, a combination of projections formed in an element of the sliding mechanism and holes made in the sliding contactor provides a stable contact between the electrical contactor and the resistor strip. As the result, a stable and reproducible positioning of the electrical contactor on the resistor strip is obtained.

For such a coupling means, a combination of through holes formed in an element of the sliding mechanism, clip holes made in the sliding contactor and clips that are set through the through holes and clip holes provides a stable contact between the sliding contactor and the resistor strip. As the result, a stable and reproducible positioning of the electrical contactor on the resistor strip is obtained.

For such a coupling means, a combination of through holes formed in an element of the sliding mechanism, rivet holes made in the sliding contactor and rivets that are set through the through holes and rivet holes provides a stable contact between the sliding contactor and the resistor strip. As the result, a stable and reproducible positioning of the electrical contactor on the resistor strip is obtained.

For such a coupling means, a combination of through holes formed in an element of the sliding mechanism, through-pin holes made in the electrical contactor and a through-pin that is set through the through holes and through-pin holes provides a stable contact between the sliding contactor and the resistor strip. As the result, a stable and reproducible positioning of the electrical contactor on the resistor strip is obtained.

The present invention further provides a mirror angle adjust mechanism that has a capability to provide high repeatability and high resolution by using such a transducer to detect the tilt angle of the mirror used for the vehicles that has the coupling means as described above.

When the resistor strip is connected to a electric power source which has a power voltage, it is possible to detect the voltage change in accordance with the change of the contact position of the sliding contactor against the resistive layer formed on the resistor strip. Since this resistor strip is installed in the guide, it is possible to save the room in the actuator housing due to such compact installation of the resistor strip.

### BRIEF DESCRIPTION OF THE DRAWINGS

FIG. 1A is a schematic that shows an actuator including tilting mechanism and used for the mirror angle adjustment for which the mirror angle transducer is used.

FIG. 1B is a schematic that shows an adjuster element and the mirror angle transducer.

FIG. 2A is a schematic that shows the head surface planner pattern of the resistor strip.

FIG. 2B is a schematic that shows the tail surface planner pattern of the resistor strip.

FIG. 2C is a schematic that shows an equivalent electrical circuit function of the resistor strip

FIG. 3A is a schematic that shows a cross section of the mirror tilting mechanism of the mirror actuator in the view along the motor axis

FIG. 3B is a schematic that shows a cross section of the mirror tilting mechanism of the mirror actuator in the view of the right angle to the motor axis.

FIG. 4A is a schematic that shows a cross section of a part of the mirror tilting mechanism in the case when the adjust nut extends most from the guide.

FIG. 4B is a schematic that shows a cross section of a part of the mirror tilting mechanism in the case when the adjust nut extends least from the guide.

FIG. 4C is a schematic that shows a cross section of a part of the mirror tilting mechanism in the case when the adjust nut extends in an intermediate length between the most extension and the least extension of the adjustment nut.

FIG. 5A is a schematic that shows a first embodiment of a coupling means that fixes the sliding contactor to the sliding block and the sliding contactor to pinch the resistor strip.

FIG. 5B is a schematic that shows a second embodiment of the coupling means that fixes the sliding contactor to the sliding block and the sliding contactor to pinch the resistor strip.

FIG. 5C is a schematic that shows a third embodiment of the coupling means that fixes the sliding contactor to the sliding block and the sliding contactor to pinch the resistor strip.

FIG. 5D is a schematic that shows a fourth embodiment of the coupling means that fixes the sliding contactor to the sliding block and the sliding contactor to pinch the resistor strip.

FIG. 6 is a schematic that shows the conventional embodiment of fixing of the sliding contactor to the sliding block and pinching of the resistor strip.

### DETAILED DISCRIPTION OF THE EXEMPLARY EMBODIMENTS

We explain the details of the exemplary embodiments of the present invention as follows.

(First Embodiment)

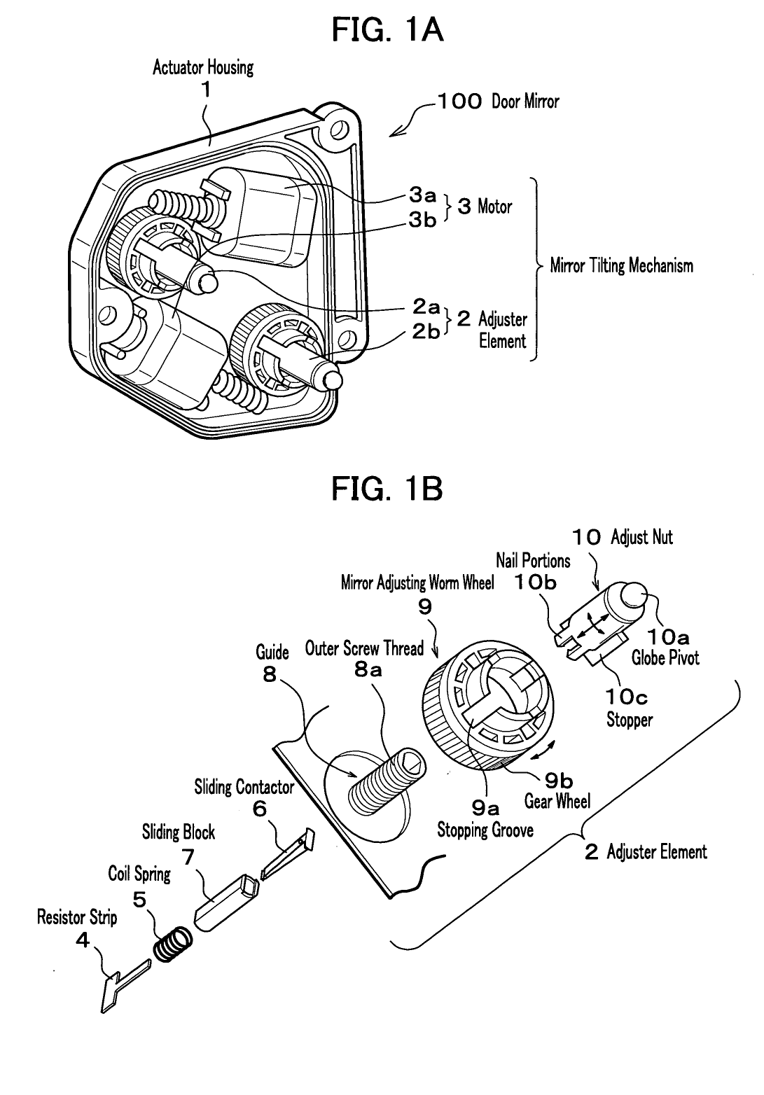

The first embodiment of the present invention is shown in FIG. 1A and FIG. 1B.

FIG. 1A is a schematic that shows an actuator used for the mirror angle adjustment for which the mirror angle transducer is used. The door mirror 100 is composed of the actuator to which the mirror angle transducer is used as shown in FIG. 1A. The mirror tilting mechanism is assembled in the actuator housing. The mirror tilting mechanism is composed of two sets of an adjuster element 2 (actually 2a or 2b), a motor 3 (actually 3a or 3b) with a worm set in the motor shaft. The detail assembly of the adjuster element 2a or 2b is shown in FIG. 1B.

There are two adjuster elements 2a and 2b used for the mirror tilting mechanism 2 constructed in the actuator housing 1. The adjuster elements 2a and 2b are driven by two motors 3a and 3b with worms, respectively and can tilt the mirror in the vertical plane and the horizontal plane.

The adjuster element 2b, for example, for the tilting mechanism 2 constructed in the actuator housing 1 is composed of a mirror angle transducer, an adjust nut 10 and a mirror adjusting worm wheel 9. More concretely, the adjuster element 2b includes a guide 8 which has a screw thread 8a formed on the outer surface thereof, an adjust nut 10 which has a globe pivot 10a, five nail portions 10b in screw contact with the screw thread 8a of the guide 8 and a stopper 10c in the cylindrical portion thereof, a mirror adjusting worm wheel 9 which includes the adjustment nut 10 inside and has a gear wheel 9b to make a screw contact with the worm attached to the motor 3 and a stopping groove 9a to meet the stopper 10C in order to rotate the adjust nut, a sliding block 7 which is inserted into the guide 8 but not rotated with the adjustment nut 10 due to the mechanical matching with the inner form of the guide 8, a resistor strip 4 which is put in the sliding block 7, a sliding contactor 6 which pinches the head and tail surfaces of the resistor strip 4 and has the electrical contact therewith and a coil spring 5 which pushes the sliding block 7 upward. The sliding contactor 6 is fixed with the sliding block 7 and is not rotated with the sliding block 7 by means of the coupling means that provides mechanically tight combining of the sliding contactor 6 to said sliding block 7.

The mirror angle transducer is composed of a guide 8, a sliding block 7 which is inserted into the guide 8, the resistor strip 4 which is put in the sliding block 7, a sliding contactor 6 which pinches the head and tail surfaces of the resistor strip 4, a coil spring 5 which pushes the slide block 7 upward and the coupling means that provides mechanically tight combining of the sliding contactor 6 to said sliding block 7. The sliding contactor 6 is fixed to the sliding block 7 not to be rotated with the sliding block 7 by means of the coupling means that provides mechanically tight combining of the sliding contactor 6 to said sliding block 7.

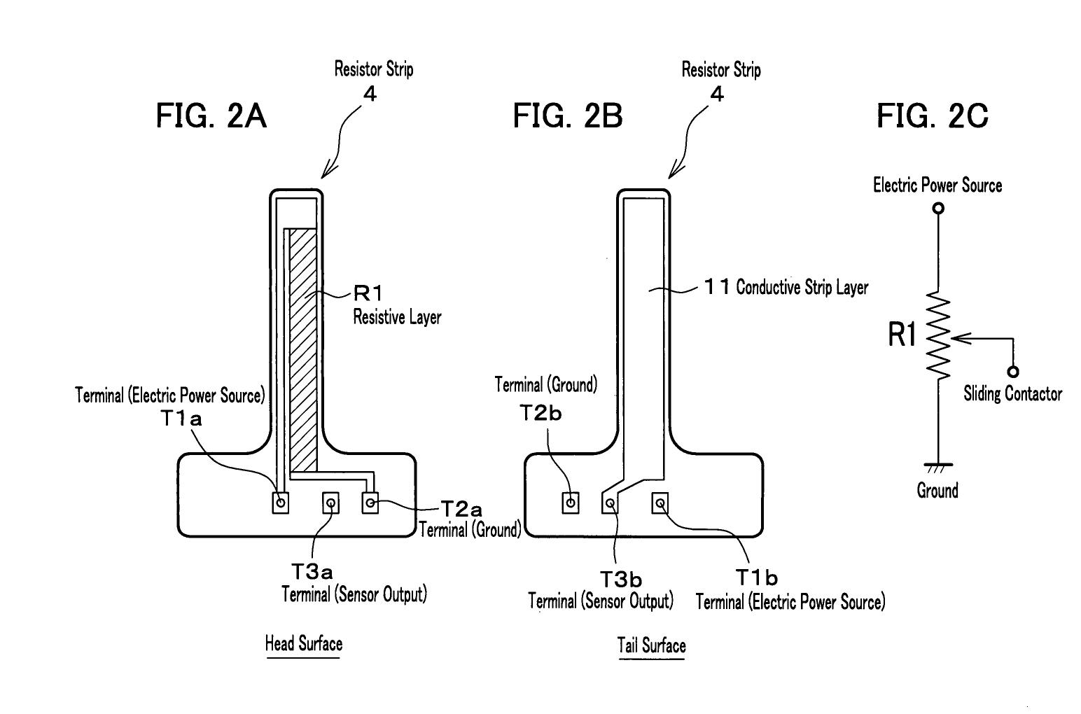

FIGS. 2A, 2B and 2C show explanatory schematics regarding the structure and pattern of the resistor strip 4. FIGS. 2A and 2B show the head and tail surfaces of the resistor strip 4, respectively. FIG. 2C shows an equivalent electrical circuit function of the resistor strip 4 and the sliding contactor 6. The resistor strip 4 has a “T” shape and three terminals T1a, T2a and T3a on the head surface and the T1b, T2b and T2c on the tail surface. As shown in FIG. 2A, the resistive layer R1 is formed on the head surface of the resistor strip 4. A conductive metal terminal layer is formed on the head surface and electrically contacts with one end of the resistive layer R1. The conductive metal terminal layer extends to the terminal T1a which is connected to an electric power source terminal. The other conductive metal terminal layer is formed on the head surface and electrically contacts with the other end of the resistive layer R1. The conductive metal terminal layer extends to the terminal T2a which is assigned as the ground terminal.

As shown in FIG. 2B, a conductive strip layer 11 is formed in the tail surface of the resistor strip 4. The terminal of this conductive strip layer 11 is terminated at a terminal T3b. Terminals T1b and T2b are connected to the electric power source terminal and the ground, respectively.

FIG. 2C shows an equivalent electrical circuit function of the resistor strip 4. The terminals T3a and T3b work as the output of the mirror angle transducer and the terminals T1a and T1b are connected to the electric power source terminal and the other terminals T2a and T2b are connected to the ground.

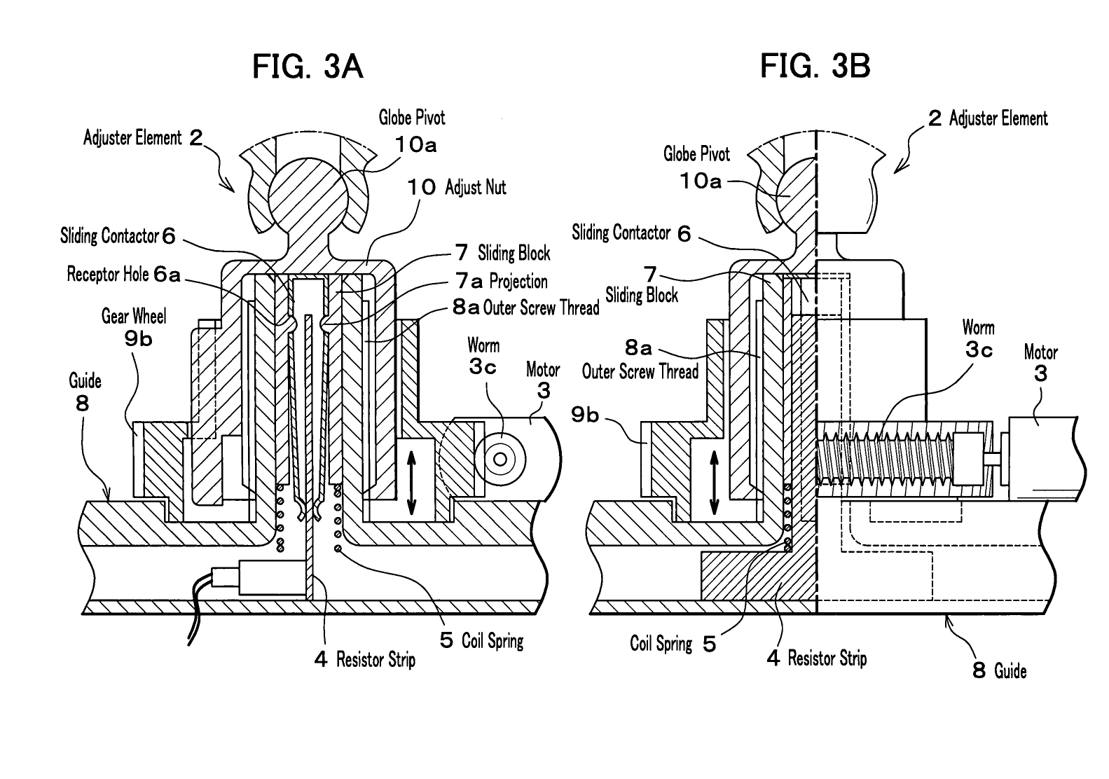

FIGS. 3A and 3B illustrate cross sections of the mirror tilting mechanism constructed in the mirror actuator in the view along to and in the right angle to the motor axis, respectively.

FIG. 3A shows that the resistor strip 4 having a resistive layer R1 and the conductive strip layer 11 as shown in the FIGS. 2A and 2B is inserted into the sliding block 7 and the sliding contactor 6 pinches the head and tail surfaces of the resistor strip 4. The sliding contactor 6 is formed into a pair of tweezers and into a half cylindrically recessed tip at the near-end tip of the sliding contactor 6. Two of the half outer cylinder surfaces are formed on the other sides of the sliding contactor 6. Therefore the tops of such cylinder surfaces make electrical contacts with the resistive layer R1 and the conductive strip layer 11, respectively, in a form of a line. The pinching force of the two cylinder surfaces potentially makes a good electrical contact. The sliding block 7 is inserted into the adjust nut 10 without friction therewith and pushed by a coil spring 5 against the adjust nut 10. A pair of receptor holes 6a are made in the sliding contactor 6 and a pair of projections 7a are formed on the inside surface of the sliding block 7. The two projections meet the receptor holes 6a made in sliding contactor 6. By this mechanical coupling, the sliding contactor 6 surely moves in accordance with the movement of the sliding block 7 driven by the adjust nut 10 to which the sliding block 7 is firmly pushed by the coil spring 5 thereto. The sliding contactor 6 is not rotated by the rotation of the adjust nut 10 since the tight fixing to the sliding block is made due to this mechanical assembly.

The actual operation of the construction given by the present embodiment is explained. When the motor 3 as shown in FIG. 1A rotates for the purpose of changing the sight angle of the mirror (not shown in the figures), the mirror adjusting worm wheel 9 (shown in FIG. 1B) which makes a screw contact with the worm to which the motor axis is inserted rotates. Since the stopper 10c formed on the cylindrical surface of the adjustment nut 10 meets the stopping groove 9a made in the mirror adjusting worm wheel 9, the adjust nut 10 rotates in accordance with the rotation of the mirror adjusting worm wheel 9. The nail portion 10b of the adjust nut 10 has a screw contact with the screw thread 8a formed on the surface of the guide 8 and therefore the nail portion 10b makes a spiral motion in accordance with the rotation of the mirror adjusting worm wheel 9.

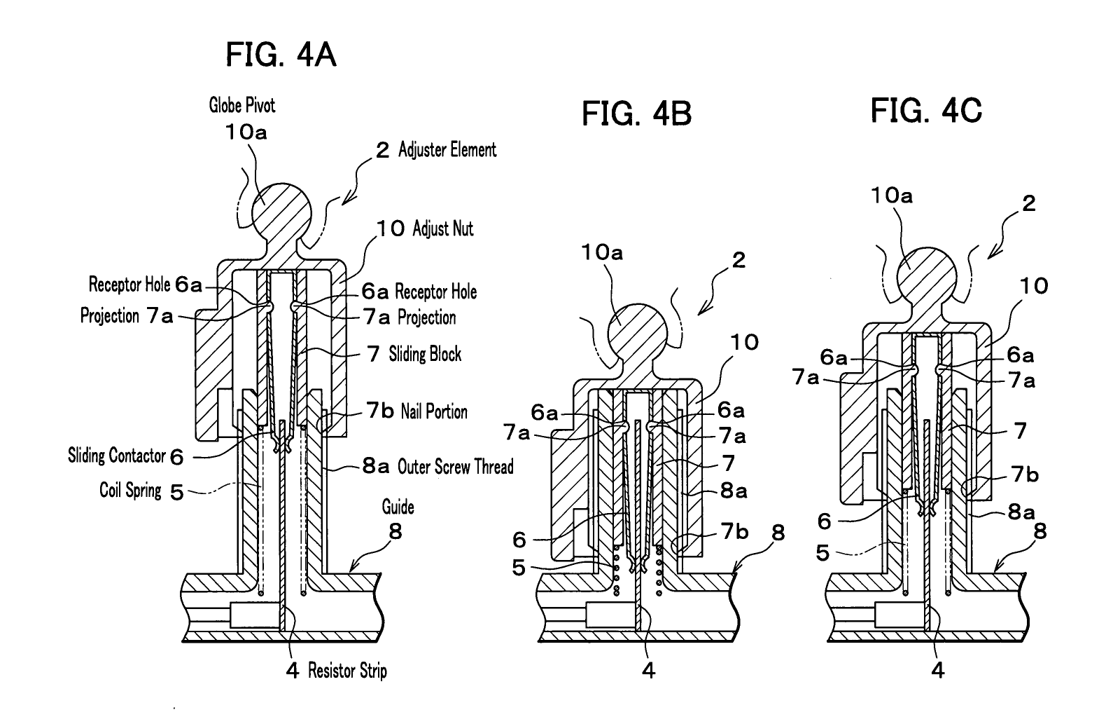

FIG. 4 shows the extension of the adjust nut 10 having a screw contact with the guide 8. More specifically, FIG. 4A shows the case when the adjust nut extends most from the guide 8, FIG. 4B the case when the adjust nut extends least from the guide and FIG. 4C the case when the adjust nut extends in an intermediate length between the most extension and the least extension of the adjustment nut. As seen in FIG. 4A, 4B and 4C, the sliding block 7 and sliding contactor 6 move up and down with the movement of the adjust nut 10. When the adjust nut 10 extends most from the guide 8 (the adjuster element 2 pushes most ahead the mirror), the sliding contactor 6 has an electrical contact with the resistive layer R1 at the closest position to the conductive metal terminal layer which extends to the terminal T1a and contacts at the closest position to one end tip of the resistor strip 4. When the adjust nut 10 extends least from the guide 8 (the adjuster element 2 pushes least ahead the mirror), the sliding contactor 6 has an electrical contact with the resistive layer R1 at the closest position to the other conductive metal terminal layer which extends to the terminal T2a and contacts at the closest position to the other end tip of the resistor strip 4. Therefore, the resistivity between the sliding contactor 4 and the terminal T1a or and between the sliding contactor 4 and the terminal T2a change with the movement of the adjust nut 10. The detail electrical operation due to the movement of the adjust nut is explained with reference to FIG. 2. The terminals T1a and T1b are connected to the electric power source and the terminal T2a and T2b to the ground. Therefore the current from the electric power source flows from the terminals T1a and T1b, the resistive layer R1 and the terminal T2a and T2b. Since the resistive layer R1 and the conductive strip layer 11 are electrically connected through the sliding contactor 6 and the conductive strip layer 11 is connected to the terminals T3a and T3b, a voltage corresponding to the contactor position of the sliding contactor 6 is obtained at the terminal T3b. Therefore when the adjust nut extends most from the guide 8, the voltage obtained at the terminal T3a is closest to the electric power source voltage. Reversely when the adjust nut extends least from the guide 8, the voltage obtained at the terminals T3a and T3b is closest to the ground voltage. The connection to the electric power source and the ground is equivalently shown as in FIG. 2C. The voltage signal output obtained by sliding contactor 6 with the resistive layer R1 is detected by the terminals T3a and T3b and corresponds to the position of the sliding contactor 6 on the resistive layer R1. Therefore the extension of the adjust nut 10 from the guide 8 that results in the tilt angle of the mirror against the actuator housing 1 can be detected by the voltage signal output.

In the present embodiment, a voltage is obtained in correspondence to the tilt angle of the mirror by using the resistor strip 4 and the sliding contactor 6 moving in accordance with the adjust nut 10. Since the resistor strip 4 and the sliding contactor 6 are set in the guide 8 especially inside of the projection part on which a screw thread 8a is formed, no large volume is required for the installation of the mirror angle transducer regarding the present invention and the space saving is possible.

Since the sliding block 7 is inserted into a non-circular hollow formed in the guide 8, which only allows the movement of the sliding block 7 along the longitudinal hollow direction, the sliding block 7 does not rotate in accordance with the rotation of the adjust nut 10. In other words, the rotation of the sliding block 7 is obstructed by the shape of the hollow formed in the guide 8 and no rotation of the sliding block 7 is made by the rotation of the adjust nut 10 which moves to adjust the mirror angle by the rotation.

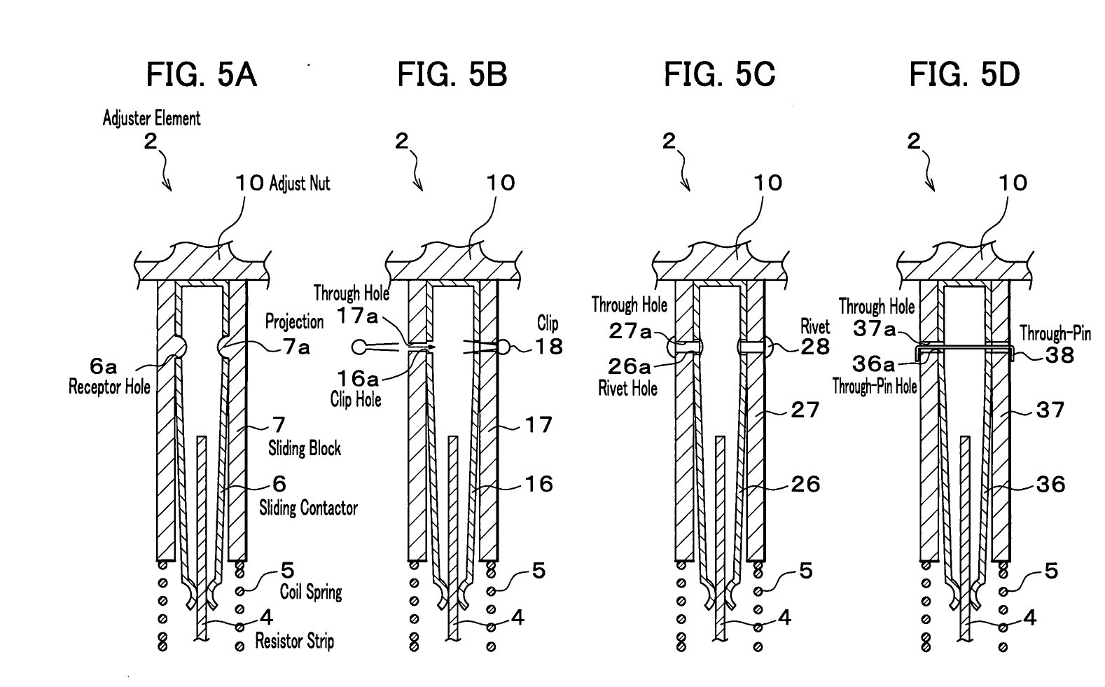

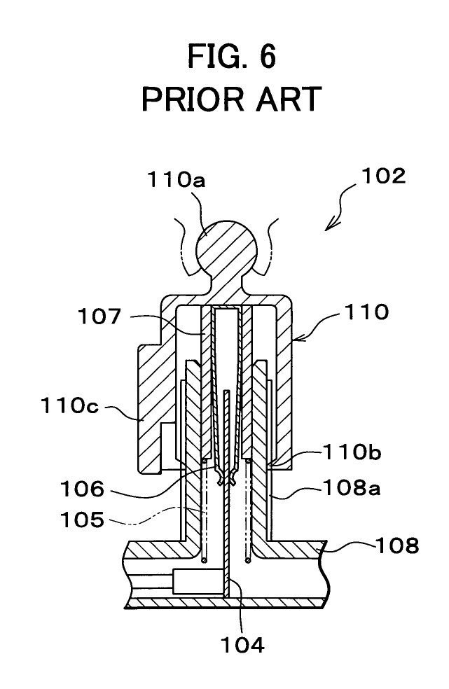

As shown in FIG. 3, FIG. 4 and FIG. 5A, the coupling means of the sliding contactor 6 to the sliding block 7 is explained in the followings. From these schematics it is seen that the sliding contactor 6 is inserted into the sliding block 7 and a pair of projections 7a formed in an inner surface of the sliding block 7 meets a pair of receptor holes 6a. The mechanical tightness between the sliding contactor 6 and the sliding block 7 is provided by the spring force of the sliding contactor 6 which is made of the metal as well as the precise design to the dimension to the hollow made in the sliding block 7. Therefore such mechanical tightness lasts long and keeps the complete stability against the rotational friction to the adjust nut 10 which mechanically contact to the sliding contactor 6 in the top inner surface thereof. The facts that no rotation of the sliding block 7 and the mechanical tightness between the sliding contactor 6 and the sliding block 7 suppresses the twist force of the contact lines of the sliding contactor 6 against the resistor strip 4 that results in stable and sufficient electrical contact, stable contact force, good reproducible positioning of the contact surface of the sliding contactor 6 with the resistive layer R1. Especially the rotational twist that changes the electrical contact of the contact surface which is provided by the cylindrical outer surface formed in the sliding contactor 6 from the line contact to the point contact is suppressed by such mechanically tight combining of the sliding contactor 6 to the sliding block 7. The pinching force by the metal material of the sliding contactor 7 is degraded by repetition of such rotational twist and becomes to be weak so that the degradation of the contact resistance between the sliding contactor 7 and the resistive layer R1 increases. This degradation causes the degradation of the repeatability of the positioning of the sliding contactor 6 and therefore the degradation of mirror angle repeatability.

The stable contact and sliding contact of the sliding contactor 6 to the resistive layer R1 without the rotation or twisting force against the resistor strip 4 provides good repeatability of the positioning, good linearity in the slide contact and no hysteresis in the voltage signal output obtained by sliding contact with the resistive layer R1. All of these effects provide high repeatability and the high resolution in the mirror sight angle adjustment.

The other embodiments, especially implemented in the coupling means are explained as follows.

(Second Embodiment)

FIG. 5B shows the second embodiment of the present invention. The difference from the first embodiment of which details are shown in FIG. 5A is that a pair of clip holes 16a, a pair of through holes 17a and a pair of clips 18 are used to make mechanical tightness between the sliding contactor 16 and the sliding block 17.

One clip 18 is inserted into one through hole 17a made in the sliding block 17 and one clip hole 16a made in the sliding contactor 16. The other clip 18 is inserted into the other through hole 17a made in the sliding block 17 and the other clip hole 16a made in the sliding contactor 16. The tips of the clips 18 become wider than the diameter of the clip holes 16a and hardly drop off from the clip holes 16a. The clips 18 make the sliding contactor 16 latched to be fixed to the sliding block 17. This latch mechanism keeps the complete stability against the rotational friction to the adjust nut 10 which mechanically contacts to the sliding contactor 16 in the top inner surface thereof.

Therefore, the stable contact and sliding contact of the sliding contactor 16 to the resistive layer R1 without the rotation or twisting force against the resistor strip 4 provides good repeatability of the positioning, good linearity in the slide contact and no hysteresis in the voltage signal output obtained by sliding contact with the resistive layer R1. All of these effects provide high repeatability and the high resolution in the mirror sight angle adjustment.

(Third Embodiment)

FIG. 5C shows the third embodiment of the present invention. The difference from the first embodiment is that a pair of rivet holes 26a, a pair of through holes 27a and a pair of rivets 28 are used to make mechanical tightness between the sliding contactor 26 and the sliding block 27.

One rivet 28 is inserted into one through hole 27a made in the sliding block 27 and one rivet hole 26a made in the sliding contactor 26. The other rivet 28 is inserted into the other through hole 27a made in the sliding block 27 and the other rivet hole 26a made in the sliding contactor 26. By using a special tool, the tips of the rivets 28 are pressed to be wider than the diameter of the rivet holes 26a and hardly drop off from the clip holes 26a. The rivets 28 stake the sliding contactor 16 to be fixed to the sliding block 27. This stake mechanism keeps the complete stability against the rotational friction to the adjust nut 10 which mechanically contact to the sliding contactor 26 in the top inner surface thereof.

Therefore, the stable contact and sliding contact of the sliding contactor 26 to the resistive layer R1 without the rotation or twisting force against the resistor strip 4 provides good repeatability of the positioning, good linearity in the slide contact and no hysteresis in the voltage signal output obtained by sliding contact with the resistive layer R1. All of these effects provide high repeatability and the high resolution in the mirror sight angle adjustment.

(Fourth Embodiment)

FIG. 5D shows the fourth embodiment of the present invention. The difference from the first embodiment is that a pair of through-pin holes 36a and a pair of through holes 37a are made and a long through-pin 38 is used to make mechanical tightness between the sliding contactor 36 and the sliding block 37.

The pin 38 is inserted into a pair of the through holes 27a made in the sliding block 27 and a pair of the through-pin holes 36a made in the sliding contactor 26. The tips of the pin 38 are bended not to fall off from the sliding block 37. This through-pin mechanism keeps the complete stability against the rotational friction to the adjust nut 10 which mechanically contact to the sliding contactor 26 in the top inner surface thereof.

Therefore, the stable contact and sliding contact of the sliding contactor 36 to the resistive layer R1 without the rotation or twisting force against the resistor strip 4 provides good repeatability of the positioning, good linearity in the slide contact and no hysteresis in the voltage signal output obtained by sliding contact with the resistive layer R1. All of these effects provide high repeatability and the high resolution in the mirror sight angle adjustment.

We have explained the preferred embodiments. Although there have been disclosed what are the patent embodiments of the invention, it will be understood by person skilled in the art that variations and modifications may be made thereto without departing from the scope of the invention, which is indicated by the appended claims. For example, we explained the embodiments that a pair of projections 7a, a pair of receptor holes 6a, a pair of clips 18, a pair of clip holes 16a, a pair of rivets 28 and a pair of rivet holes are used. However these can be more than three projections 7a, three receptor holes 6a, three clips 18, three clip holes 16a, three rivets 28 and three rivet holes are used.

In order to keep the stable contact between the resistor strip 4 and the sliding contactors 6, 16, 26 or 36, a pair of grooves or slits in which the both sides of the resistor strip 4 are inserted and guided can be formed in the longitudinal sides of the sliding block 7.

1. A mirror angle transducer that detects tilting angles of a mirror applied to a vehicle, wherein said tiling angle is adjusted by an adjuster element installed in an actuator housing, comprising;
a guide that has a non-circular hollow and composes said adjuster element,
a sliding block that has a hole and is inserted into said non-circular hollow of said guide,
a coil spring that pushes said sliding block to an orientation along said non-circular hollow,
a resistor strip that has a resistive layer and a conductive strip layer on one surface and the other surface, respectively and is set in said hole of said sliding block,
a sliding contactor that makes electrical contact with said resistor strip by pinching and sliding on said surfaces of said resistor strip, and
a coupling means that provides mechanically tight combining of said sliding contactor to said sliding block.

2. A mirror angle transducer according to claim 1, wherein said coupling means is composed of projections formed in an inner surface of said sliding block and receptor holes formed in said sliding contactor in such a construction that said projections meet said receptor holes.

3. A mirror angle transducer according to claim 1, wherein said coupling means is composed of through holes formed in said sliding block, clip holes formed in said sliding contactor and clips that are inserted into pairs of said through holes and said clip holes.

4. A mirror angle transducer according to claim 1, wherein said coupling means is composed of through holes formed in said sliding block, rivet holes formed in said sliding contactor and rivets that are inserted into pairs of said through holes and said rivet holes.

5. A mirror angle transducer according to claim 1, wherein said coupling means is composed of through holes formed in said sliding block, through-pin holes formed in said sliding contactor and a through-pin that is inserted into pairs of said through holes and said clip holes.

6. A mirror tilting mechanism which has a capability to detect tilting angles of said mirror applied to a vehicle, wherein said mirror angle transducer according to claim 1 installed in said adjuster element, a motor with a worm set in a motor shaft thereof and an electric power source are used for said capability to detect said tilting angles thereof, including a worm wheel engaged with said worm and an adjust nut rotated by said worm wheel that make linear displacement with which said sliding contactor and said sliding block move and said mirror angle transducer generates an output signal thereby.

7. A mirror tilting mechanism which has a capability to detect tilting angles of said mirror applied to a vehicle, wherein said mirror angle transducer according to claim 2 installed in said adjuster element, a motor with a worm set in a motor shaft thereof and an electric power source are used for said capability to detect said tilting angles thereof, including a worm wheel engaged with said worm and an adjust nut rotated by said worm wheel that make linear displacement with which said sliding contactor and said sliding block move and said mirror angle transducer generates an output signal thereby.
